(19) United States
(12) Patent Application Publication
(10) Pub. No.: US 2009/0021012 A1
(43) Pub. Date: Jan. 22, 2009

(54) INTEGRATED WIND-POWER ELECTRICAL GENERATION AND COMPRESSED AIR ENERGY STORAGE SYSTEM

(76) Inventors: Mark A. Stull, Bedford, NH (US); Thomas A. Muckle, Old Lyme, CT (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/780,714

(22) Filed: Jul. 20, 2007

(51) Int. Cl. F03D 9/02

(52) U.S. Cl. 290/44; 290/55; 290/1 A; 60/659

(57) ABSTRACT

The present invention relates to a method and apparatus for using wind energy to compress air or pressurize a fluid as a means of storing energy. Compressed air or pressurized fluid is generated directly by the wind turbines, thereby avoiding the energy losses that occur when wind power is used first to generate electricity to run an electrically powered air compressor. The compressed air or pressurized fluid is stored by means of expanding a volume at constant or nearly constant pressure. This method avoids energy losses that would otherwise result from compressional heating; while also allowing lower pressures to be employed, reducing the cost of the containment facility and avoiding the need to locate facilities in geographically favored locations where underground storage is available. The invention permits both large and small-scale storage at low cost per unit of energy stored, thereby avoiding the difficulty of using a highly variable and unreliable source of energy such as the wind for electrical power generation. The invention can be used for generation and storage on land, in shallow near-shore waters and in deep-water locations far from shore.

### FIELD OF THE INVENTION

The present invention relates to a method and apparatus for using wind energy to compress or pressurize air or other fluid medium as a means of storing energy and more particularly, to a system and method wherein the compressed air or pressurized fluid is stored by means of expanding a volume at a constant or nearly constant pressure generated by an applied force. This invention relates to an integrated system for harvesting and storing the kinetic energy of the wind and converting it to electrical power on an as-needed basis. The invention can also be used to provide a means for compressing air using wind energy.

### BACKGROUND OF THE INVENTION

Wind energy is becoming increasingly important as a source of electrical power. Wind power does not entail the use of fossil fuels; therefore it both promotes energy independence and is non-polluting; in particular, it avoids greenhouse gas emissions. Furthermore, the cost of wind energy technology has declined, making wind power economically attractive as well.

Unfortunately, wind power suffers from a major negative: the wind is a highly variable energy source that cannot be relied upon to produce power at times of high demand, and, perversely, may produce excess power at times of low demand. This has several adverse consequences. Large-scale reliance on wind energy may create stability problems for the power grid. The need to meet peak loads during light winds can require the construction of excessively large and expensive facilities. For a typical facility the capacity factor, which is the percentage of the rated power that is converted to electricity, is only about 30%, simply because the rated power cannot be generated in light winds. And the unreliability of the wind makes wind power unsuitable for stand-alone generation without a back-up power source.

These deficiencies can be greatly ameliorated through the use of an energy storage system. But this, too, poses problems. Electricity is both difficult and expensive to store. Probably the most common means of storing electrical energy, the lead acid battery, can cost up to several hundred dollars per kilowatt-hour and can create environmental hazards. Therefore modern windfarms do not generally utilize energy storage systems.

It has long been recognized that Compressed Air Energy Storage (CAES) is a promising approach to reducing both the costs and environmental impacts of power storage. In a typical CAES system, electricity is used to run air compressors during periods of low power demand. The compressed air is then stored in some kind of containment vessel. Then, during periods of high power demand, the stored compressed air is released and the expanded air utilized to run turbines that generate electricity. A fuel, typically natural gas, can be burned with the expanding air to raise its temperature and improve the efficiency of the system. In essence, a conventional CAES system is a modified turbine-generator. In a conventional turbine, a significant amount of fuel is burned simply to run an air compressor to supply the pressurized air needed by the turbine. A CAES system eliminates the need to burn this fuel by supplying the compressed air; however, it does not save energy, because energy is still required to compress the air.

CAES also has suffered from deficiencies that have prevented its widespread use. As of mid-2005, there were only two operational CAES facilities in the world, an Alabama facility that has operated since 1991 and a facility in Germany that came on line in 1978, although several more are now under development.

One deficiency that has plagued CAES is the need for large containment facilities to store the required volume of pressurized air. The mechanical energy stored by compressing a gas is equal to the excess of the pressure over atmospheric pressure times the volume in which the gas is contained. Thus large-scale storage requires large volumes, high pressures, or both. But pressure vessels strong enough to contain a large volume of highly pressurized gas are prohibitively expensive on a per kilowatt-hour basis. Therefore existing CAES systems rely upon underground storage facilities, in which natural formations such as caverns provide the required containment. Although this avoids the cost of large containment vessels, it severely limits the locations at which CAES facilities can be built.

Another deficiency from which CAES suffers is inefficiency. Energy losses in a CAES system can be substantial and can far exceed the losses typical of other types of energy storage. A principal loss mechanism in CAES is compressional heating. From basic principles of thermodynamics it can be shown that when a gas is compressed adiabatically at constant volume, the temperature of the gas varies directly as the pressure; specifically, the rate of change of temperature with pressure is given by

$$\frac{d T}{d P} = \frac{γ - 1}{γ} {P}^{- 1 / γ} \qquad Equation 1$$

where γ designates the ratio of the heat capacity of the gas at constant pressure to the heat capacity at constant volume. For air γ is approximately 1.4. Hence the above derivative is positive. Integrating, the change in temperature resulting from an increase in gas pressure from P₁ to P₂ is T₁[(P₂/P₁)^{2/7}−1], where T₁ is the initial temperature. Once stored, the heated compressed gas will come to thermodynamic equilibrium with its surroundings by losing an amount of energy proportional to the temperature increase; the greater the pressure increase, the greater the energy loss. As can be seen, this energy loss can drastically reduce the efficiency of a CAES system.

Notwithstanding these deficiencies, the desirability of using CAES to store wind energy, and thereby ameliorate the deficiencies resulting from the variability of the wind as an energy source, has been recognized, as, for example, in the report “The Economic Impact of CAES on Wind in Texas, Oklahoma and New Mexico”, dated Jun. 27, 2005, by Ridge Energy Storage & Grid Services, L.P. According to the report, there are significant benefits to be gained from the use of CAES to integrate large quantities of wind energy into the power grid. Specifically, CAES can improve the shape in which wind energy is delivered into the grid by matching the supply of wind energy at any given time to the load at that time, CAES/wind facilities can supply base-load generation needs and thereby defray the development of alternative generation facilities, and CAES/wind facilities can mitigate adverse impacts on the power grid that would result from wind alone whenever high winds occur during periods of low power demand, while, under a range of scenarios, “the combined cost of 270 MW of CAES with 500 MW of new wind would be competitive with conventional generation resources that might be considered as an addition to the grid.” The system considered in the report consisted of conventional wind turbines, which use wind energy to turn the armature of a generator located in the nacelle of the windmill to generate electricity, an air compressor powered by the electricity generated by the wind turbines, an underground cavern for storage of compressed air pressurized to 1250 psi, a fuel supply for fuel, generally natural gas, to be burned to heat the compressed air, a high-pressure turbine, a low-pressure turbine, a recuperator to capture waste heat from the turbines and use it to reduce fuel consumption for compressed air heating, and a generator. This model combines a conventional wind turbine with a conventional CAES system and is representative of the current state of the art, although there is some prior art that does address the manner in which utilization of CAES by wind energy systems can be improved over the conventional model described above.

In U.S. Pat. No. 7,067,937, a complicated system is employed wherein a portion of windmill stations are devoted to energy generation and a portion to energy storage. The energy storage stations transmit mechanical rotational energy generated by the rotating windmill blades via a mechanism consisting of a series of gears and horizontal and vertical shafts to an air compressor on the ground. The compressed air is then stored in pressure vessels in the traditional manner, as an energy source for periods of high demand and/or light winds. The energy generation stations utilize conventional wind turbines, with an electrical generator located in the nacelle of the windmill, to generate electricity. This invention achieves an improvement in cost and efficiency by partially eliminating the two-step process of converting the mechanical energy of the wind to electricity and then converting the electricity generated back to mechanical energy stored in the compressed air; instead it uses a one-step process of converting wind energy directly to compressed air. Nevertheless, deficiencies remain. Among these, the energy generation stations must still rely upon fluctuating winds to meet variable loads, the system of gears and shafts required by placing the compressors on the ground is subject to frictional energy losses and mechanical wear, the energy losses resulting from compressional heating are not diminished in any way (it is these that necessitate the otherwise inefficient employment of energy generation stations in addition to energy storage stations), and the invention must still either employ expensive pressure containment vessels or rely upon locations at which favorable geologic formations exist.

In U.S. Pat. No. 6,863,474, the invention also eases, but does not eliminate, the need to rely on locations with special geological features. Compressed air is generated by any means and stored underwater in storage vessels composed of a flexible material that can collapse, but does not stretch. When compressed air is injected into the storage vessel, it expands. However, this invention is not specifically designed for wind power storage; instead it relies upon generation of compressed air by electrically powered compressors. The requirement for underwater storage locations still restricts the location of the storage facility to places where water of the desired depth is present. Although this would seem not to be a problem for offshore windfarms, other problems arise. If storage bladders are located at shallow depths, large storage volumes are required, and this need cannot be avoided by the use of many small bladders because materials costs depend on surface area, which increases as the square of the linear dimension, while storage volume increases as the cube of the linear dimension. Thus the materials cost of storage bladders per kilowatt-hour is lower for large bladders than for small ones, but large bladders may require higher fabrication costs and may also be more vulnerable to damage. More importantly, inflated bladders will float unless they are either tethered or anchored. Tethering at great depths is likely to be expensive, especially for large bladders, perhaps prohibitively so. Anchoring, on the other hand, may require a massive anchor. The anchor mass needed can be obtained from Archimedes' principle, which requires that the weight of the water displaced by the volume of the bladder plus the weight of the water displaced by the volume of the anchor be counterbalanced by the weight of the anchor plus the weight of the bladder. Thus the necessary mass is given by

ρₐV_{b}(ρ_{w}−ρ_{b})/(ρₐ−ρ_{w}) Equation 2

where V_{b} is the volume of the expanded bladder and ρₐ, ρ_{w}, and ρ_{b} represent, respectively, the densities of the anchor, the surrounding water, and the gas-filled bladder. Use of a material for the anchor much denser than water, such as iron or lead, can reduce the required mass and volume of the anchor; however, the cost of the material required could prove prohibitive.

Accordingly, what is needed is an integrated power generation and storage system that will convert wind energy directly to compressed air or an alternative storage medium, enable most or all available wind energy to be captured, reduce or eliminate energy losses from compressional heating, provide for use in any location, on land or off-shore, where large amounts of wind power are available, avoid introducing new energy loss mechanisms, and minimize costs. Such a system should be both more efficient and less costly than its predecessors and, properly sized for the wind profile at a given site should be capable of capturing and using a very high percentage of the available wind.

### SUMMARY OF THE INVENTION

An integrated wind power generation and storage system according to the present invention includes (i) a windmill having tower-mounted vanes that rotate when the wind blows, turning a rotatable shaft; (ii) an optional transmission system of one or more gears and clutches that can be used to control the rate at which power is transmitted to (iii) a rotating or piston-driven air compressor or pump located in the nacelle of the windmill or elsewhere; (iv) a feed system by which compressed air or a pumped, pressurized fluid is conducted to and injected into a storage unit at the desired pressure, typically by means of a feed with an adjustable valve or nozzle; (v) a storage unit in which energy storage is accomplished by expanding the volume of compressed air or pressurized fluid at constant or nearly constant pressure against a generated force that may be created by any means, which means may be the weight of a solid or liquid, a spring or other mechanical means, or an electromagnetic means; (vi) a containment mechanism that prevents the compressed air or pressurized fluid from escaping while the storage unit is partially or totally expanded; (vii) a feed system that conducts compressed air or pressurized fluid from the storage unit to a device that generates rotational motion and injects it into that device at the desired pressure, typically by means of a feed with an adjustable valve or nozzle; (viii) a device for generating rotational motion to rotate the armature of a electrical generator, which device may be one or more air motors, hydraulic motors, or high or low pressure turbines; (ix) an electrical generator which may be either a direct-current generator or an alternating current generator; and (x) one or more governors and other controls that can regulate air or fluid pressure throughout the system, prevent over-pressurization of the storage unit, and match the instantaneous energy input to the electrical generator to the instantaneous electrical load, maintaining required frequency stability.

In use, conventional tower-mounted windmill vanes are turned by the wind to rotate a shaft, which operates an air compressor or a pump, which pushes compressed air or pressurized fluid into a feed tube that carries it to the storage unit. At or prior to the point of injection into the storage unit there is a valve or nozzle that may be completely closed or opened to any diameter up to the diameter of the compressed air/pressurized fluid feed. The compressor or pump, feed tube and injection nozzle constitute an air/fluid injection system that is controlled in such a manner that as the wind speed varies up and down, a constant pressure is maintained at the injection point, while the volume of air or fluid per unit time injected into the storage unit is permitted to fluctuate. When the wind speed drops below the level at which sufficient rotational energy can be generated to maintain the required pressure, the injection nozzle closes completely, sealing off the storage unit.

The storage unit operates by expanding a volume against a constant or slightly varying force. The pressure within the storage unit is determined solely by the force against which it is expanded; thus, the expansion is caused to take place at constant or nearly constant pressure. For example, in one embodiment of the invention, the storage unit consists of a cylinder and piston, the head of which is held down by the force of a weight of solid and/or liquid above it. As air or fluid is injected into the cylinder, the piston head is lifted, increasing the volume of the cylinder. To lift the piston head, the pressure maintained at the inlet must be at least equal to the height of the material in the piston head multiplied by its density and the acceleration due to gravity. As air or fluid flows into the cylinder, the piston head is naturally caused to rise at a rate which maintains that pressure, although the rate itself will vary in accordance with the volume of air or fluid being injected into the cylinder per unit time. In other embodiments of the invention, other means are used to generate the force against which the compressed air or pressurized fluid is expanded, as for example, the force generated by a spring.

Compressed air or pressurized fluid is contained in the storage unit by providing a means of sealing the storage unit. In one embodiment of the invention, the seal is created by the use of an inexpensive liquid, such as water, to provide the weight that generates the force against which stored compressed air is expanded. For pressurized fluid, the seal is created by containing the fluid within an expandable bladder, which is expanded against the applied force.

For offshore wind farms or those adjacent to a body of water, the pressure of the water at a selected depth can be used to provide the force against which the volume of compressed air can be expanded. A pressurized fluid cannot be used in this application. In one embodiment of the invention the means for this can be an inflatable bladder. However, the preferred embodiment of the invention for this circumstance does not rely upon an inflatable bladder; instead it employs the required anchor in a dual role. Specifically, it employs a hollow anchor, shaped so that one end of the hollow chamber will always be at the bottom, with one or more holes at that end so that water can freely flow into and out of the chamber. Compressed air forced into the chamber will rise to the top and force water out of the chamber, thereby providing the desired volume expansion, while when compressed air is withdrawn from the chamber via a feed at the top of the chamber, water will flow back into the bottom of the chamber, reducing the storage volume. The pressure within and without the chamber will be equal to the water pressure at the depth chosen. To a high degree of approximation, the volume of material required for the entire hollow anchor, per unit energy stored, is inversely proportional to the density of the material used times the depth of the water, while the mass per unit energy stored is inversely proportional to the depth of the water. Since the cost of the hollow anchor depends on the mass, the volume, or both, lower storage costs per kilowatt-hour stored can be achieved by placing the unit at greater depths.

The invention achieves further efficiencies and cost savings by integrating the means of electric power generation with the means of energy storage.

In one embodiment of the invention compressed air is withdrawn from a storage chamber via a feed and used to create rotational motion by expanding the air against the vanes of a turbine or air motor, which turns a conventional generator. In another embodiment of the invention the compressed air is similarly withdrawn from the storage chamber, but is used instead to compress a hydraulic fluid which turns a hydraulic motor or hydraulic turbine. In another embodiment of the invention the compressed air drives pistons which are used to turn a shaft that is connected to the armature of the generator, causing it to rotate. In embodiments of the invention which employ a pressurized fluid rather than compressed air, the pressurized fluid is used to drive a hydraulic motor or turbine. Use of a pressurized fluid rather than compressed air enables employment of turbine systems similar to those in hydroelectric power plants, which can achieve efficiencies of over 90%.

One object of this invention is to provide a means for using ambient winds to compress air and inject it into a storage unit at a specific pressure, without first generating electricity as would a conventional wind turbine.

Another object of this invention is to provide a means for capturing and storing all or nearly all of the available wind energy so that it can be turned into electricity as needed, rather than only when the wind is blowing.

Another object of this invention is to eliminate fluctuations in power output caused by the variability of the wind speed, and to provide, instead, a power output always matched to the load.

Another object of this invention is to provide a means for compressing air for any use that may be made of compressed air, using mechanical wind energy directly, rather than using a conventional air compressor, powered by a motor run on electricity or fuel.

Another object of this invention is to create a means of compressed air energy storage by expanding a volume at constant pressure, in order to reduce or eliminate energy losses that would otherwise result from compressional heating.

Another object of this invention is to provide an economical means for storing compressed air for CAES in an artificial container rather than in a natural rock formation, by avoiding the need for great strength in the container through equalization of the pressure forces on both sides of the container.

Another object of this invention is to permit CAES to be used to store wind energy at any location, on land or off-shore, where a suitable wind profile exists for a wind power facility to generate the desired amount of power, large or small.

Another object of this invention is to provide a means for anchoring an underwater storage unit at minimal additional cost, by using the anchoring mass for more than one purpose, for example, by using the mass of the required turbine and other system components as part of the anchoring mass.

Another object of this invention is to provide a means of sealing the compressed air within the storage unit.

Another object of this invention is to minimize the cost of a CAES facility.

Another object of this invention is to generate electricity from compressed air by integrating the means of generation with the means of storage, thereby increasing efficiency and reducing costs.

Another object of this invention is to increase the efficiency of electric power generation and storage by using hydraulic fluids instead of compressed air.

It is important to note that the present invention is not intended to be limited to a system or method which must satisfy one or more of any stated objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims and their legal equivalents.

### BRIEF DESCRIPTION OF THE DRAWINGS

These and other features and advantages of the present invention will be better understood by reading the following detailed description, taken together with the drawings wherein:

FIG. 1 is a schematic drawing that shows an enlargement of the nacelle of a wind turbine;

FIG. 2 is a schematic drawing of an integrated wind power generation and CAES storage system for inland power generation systems, with above-ground storage showing displacement of a liquid as the means for expanding volume in accordance with the present invention;

FIG. 3 is a schematic drawing of an integrated wind power generation and CAES storage system for inland power generation systems, with above-ground storage showing a movable weight or piston as the means for expanding volume in accordance with the present invention;

FIG. 4 is a schematic drawing of an integrated wind power generation and CAES storage system for off-shore or shore-line power generation stations, with underwater storage in accordance with the present invention; and

FIG. 5 is a chart illustrating the materials cost per kilowatt hour for an underwater spherical storage unit as a function of diameter and depth (both in meters).

### DETAILED DESCRIPTION OF THE INVENTION

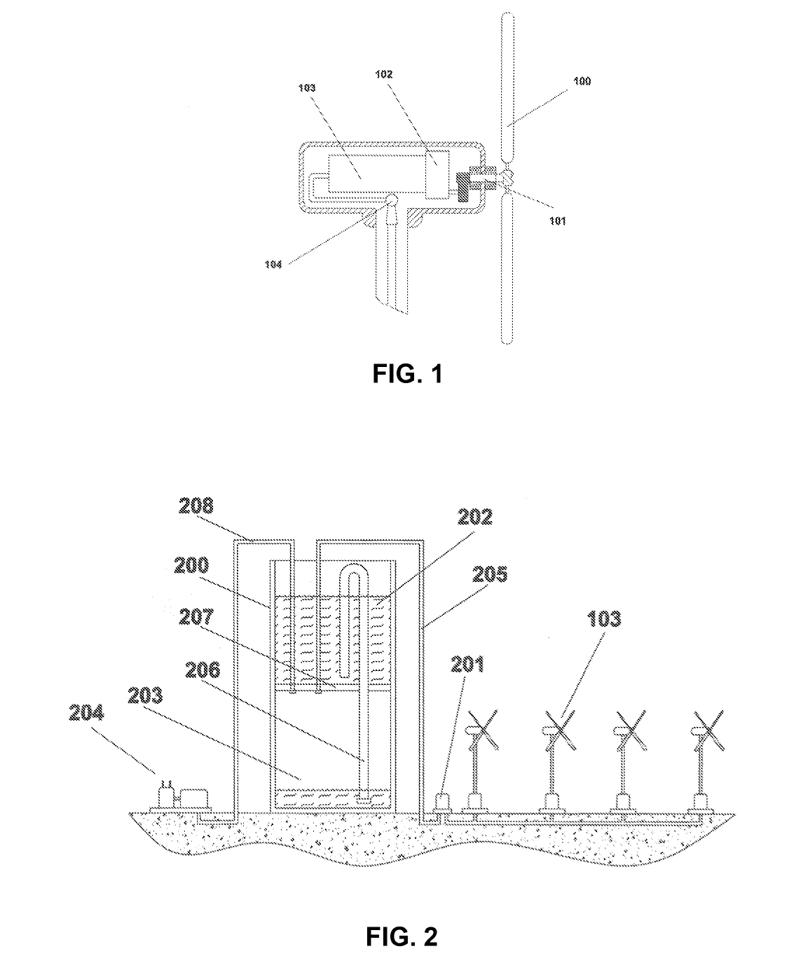

An integrated wind power generation and CAES storage system according to the present invention will now be described in detail with reference to FIGS. 1 through 5 of the accompanying drawings.

The invention comprises several methods and apparatuses which include one or more wind-powered air compressors or pumps, and one or more storage units for storing the compressed or pressurized air or other fluid medium. The volume of the storage unit is expanded at constant or nearly constant pressure by the compressed air or pressurized fluid inflow. Compressed air/pressurized fluid feeds with control valves feed compressed air or pressurized fluid from the wind-powered compressors or pumps to the storage units. The system includes a means for generating electricity by withdrawing compressed air or pressurized fluid from the storage units, which means may include one or more air turbines, hydraulic turbines and generators, as well as valves and feeds, and one or more governors which control the rate at which compressed air is withdrawn to meet instantaneous power demand.

This mode of operation differs from conventional CAES systems, in which a gas is pressurized at constant volume. One advantage of this is that it can greatly improve the efficiency of the CAES system by reducing or eliminating energy losses due to compressional heating. Although, if air is used as the storage medium, it must still be compressed with resulting heat generation, the subsequent expansion of the storage volume against an applied force provides an additional means of energy storage, which, in turn, allows heat energy to be captured and stored.

The means of expanding a volume against an applied force augments the amount of energy stored because work is done against the applied force. In conventional CAES the energy stored is simply the storage volume used times the excess of the pressure over atmospheric pressure. This can be contrasted with the storage technique often called pumped hydro, in which energy is stored by pumping water from a lower elevation to a higher elevation. In pumped hydro, which also is not commonly employed because of the need for special geographies and/or dams, the total energy stored is just the increase in the gravitational potential energy of the water pumped uphill. However, in the present invention, when a volume is expanded against an applied force, both means of energy storage are combined; the total energy stored is equal to the storage volume used times the excess of the pressure over atmospheric pressure plus the work done against the applied force (which may be the force of gravity, the force generated by a spring, or any other force).

The increased potential energy of the system can be supplied by the heat generated by compression of air or any other fluid that is used. There are two means for doing this.

In one means thermal insulation is used to prevent the escape of compressionally generated heat as air travels from the compressor to the storage unit; if the escape of heat from the storage unit is also retarded by the use of insulation, then the heat content of the compressed air can be made to cause an incremental overpressurization of the storage unit, with the result that the air in the storage unit will expand against the applied force and cool. The heat energy is thereby made to do the work of expanding the unit against the applied force. This approximates an adiabatic process.

The other means of using and storing the heat of compression approximates an isothermal process. In this means, a heat exchanger is used to capture the heat of compression at the compressor and transport it to the storage unit, where it is supplied to the stored compressed gas, again resulting in an incremental overpressurization that results in expansion and cooling of the storage volume. The process is approximately isothermal because the compressed air is maintained at constant temperature throughout the system, in contrast to the first means, which causes the temperature of the compressed air to increase. The choice between the two means depends on their efficiency and cost for the particular application in question.

The wind-powered air compressor is described with reference to FIG. 1. Conventional rotors 100 are turned by the wind, causing a shaft 101 to rotate. The shaft may be connected to a transmission system 102, which controls the rate at which an air compressor 103 is driven. Compressed air flows into the feed to the storage unit via a valve 104, which can be closed if required by operational needs. In other embodiments of the invention, the wind-powered compressor may be located elsewhere than the nacelle of the wind turbine (not shown).

One embodiment of the storage unit is described with reference to FIG. 2. In this embodiment, which is a preferred embodiment for inland locations where above-ground storage is required, the storage unit 200 includes an upper chamber 202 and a lower chamber 203. When the storage unit 200 is discharged, the lower chamber 203 is filled with a fluid, which may be water, the density of which is ρ_{φ}. Compressed air having density ρₐ flows from the wind-powered compressors 103 into the feed 205. The compressed air flows through the feed 205 at velocity v, and enters the storage unit 200. The flux of air (ρₐv) in the feed 205 is permitted to vary as the wind speed changes. The pressure, P, of the air flowing through the feed 205 is controlled so that it is equal to gHρ_{φ}+Δ, where g is the acceleration due to gravity, 9.8 meters/second, H is the height of the pipe 206, through which fluid can freely flow from the lower chamber 203 to the upper chamber 202, and Δ is an increment of pressure which may be arbitrarily small, except that it must be sufficient to compensate for any pressure drop resulting from friction with the walls of the pipe 206 and eddies in the flow. When compressed air is added to the lower chamber 203, fluid is forced into the upper chamber 202, through the pipe 206. When compressed air is withdrawn from the lower chamber 203, fluid flows back into the pipe 206, and then into the lower chamber 203. The pressure regulator valve 201 is a system backup to insure that, in the event of a wind-powered compressor failure, or a leak in the feed from the compressor, high-pressure air does not escape from the system.

The pressure P maintained in the feed 205 is equal to the pressure at the bottom of the pipe 206 when completely filled by fluid, plus Δ; it is just sufficient to force air into the lower chamber 203, thereby causing the fluid in the lower chamber 203 to be displaced through the pipe 206 into the upper chamber 202. If the upper and lower chambers have the same dimensions (this need not be true), the energy storage capacity will be equal to the sum of the stored mechanical energy, plus the increase in the gravitational potential energy of the raised fluid in the upper chamber 202, E=PV+gm_{φ}h=Vρ_{φ}g(H+h), where m_{φ} represents the mass of the fluid, V is the volume of the fluid, which is the same as the volume of the lower chamber, and h represents the height of each chamber. A pressurized fluid can be used instead of compressed air if the fluid is pumped into an expandable bladder located in the lower chamber (not shown).

When compressed air is withdrawn from the lower chamber 203, it is carried via a feed 208 to an electrical generation station 204, where it is used to turn an air motor or air turbine, which rotates the shaft of a generator. Alternately, the compressed air is used to provide the pressure to compress a hydraulic fluid, which turns a hydraulic motor or turbine to create the rotational motion for the generator shaft. The compressed air can also be expanded to drive a reciprocating engine/generator. When a pressurized fluid is used for the storage medium instead of compressed air, the pressurized fluid is withdrawn and conveyed via the feed 208 to operate a hydraulic motor or turbine.

The resulting cost of energy storage can be made extraordinarily low. The cost of the storage unit is the materials cost plus the construction cost. Since there are no moving parts and no consumables to replenish, operational costs are minimal. Materials costs can also be very small per unit of energy stored. The internal components of the storage unit 200, the partition 207 between the upper and lower chambers 202, 203 and the pipe 206 will not be subject to differentials in force and therefore need not have the strength or rigidity required to withstand significant loads. On the other hand, the walls of both the upper and lower chamber must support the pressure of the air and fluid inside the chambers. However, this can be accomplished through the use of inexpensive structural materials such as concrete, since much lower pressures than used in conventional CAES, on the order of 25 to 150 psi, can provide adequate energy storage. In general, cost per unit of energy stored will be less for larger capacities. Costs as low as a few dollars per kilowatt hour may be attainable.

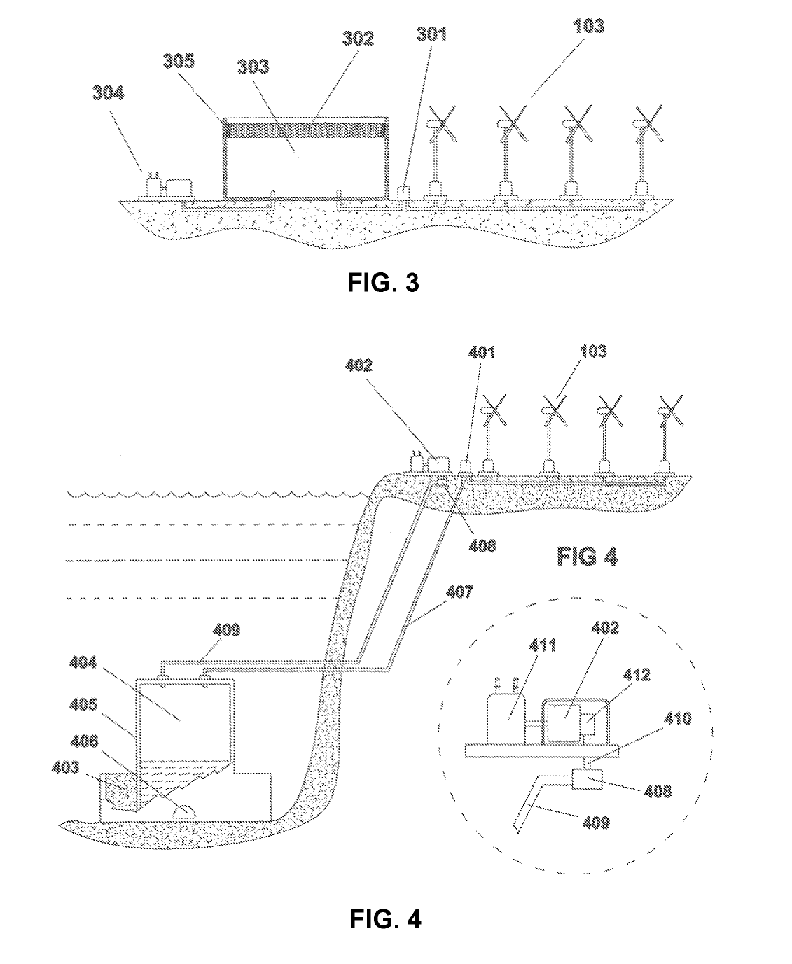

A second embodiment of the invention is described with reference to FIG. 3. In this embodiment the storage unit includes a chamber 303 and a movable weight 302, which can be raised and lowered, the density of which is ρ_{w} and the height of which is h_{w}. The volume of the chamber 303 is V=Ah, where A is its cross-sectional area and h is its height. When the storage unit is discharged, the weight 302 is in its lowest position. Compressed air or pressurized fluid flows from the wind-powered compressors 103 or pumps through the feed and valve 301 and enters the storage unit at the bottom. The compressed air is contained below the weight 302 by a seal 305 that closes the space between the weight 302 and the chamber wall, preventing the air from escaping; when pressurized fluid is used, it is contained by means of pumping it into an expandable bladder made of an impenetrable, deformable material such as rubber or the like. The pressure of the compressed air or pressurized fluid in the feed 301 is controlled such that it equals gρ_{w}h_{w}+Δ, where Δ is an arbitrarily small increment of pressure. This is just sufficient so that as compressed air or pressurized fluid is fed into the chamber 303, the weight 302 will be caused to rise until it reaches its maximum permissible elevation, thereby expanding the volume occupied by the compressed air or pressurized fluid at constant pressure. The seal 305 can be implemented by any conventional means and may alternatively be implemented by containing the air within an expandable bladder, as when a pressurized fluid is used, that, when fully expanded, will have interior volume equal to the volume of the chamber 303. The energy storage capacity of the chamber 303 will be equal to the sum of the stored mechanical energy plus the increase in the gravitational potential energy of the raised weight 302, PV+ghm_{w}=gρ_{w}A(h²+h_{w}²), where m_{w} represents the mass of the weight 302. Other embodiments of the invention contemplate alternate means of creating a force against which a volume of compressed air can be expanded at constant pressure, such as one or more springs. Compressed air or pressurized fluid is withdrawn from the chamber 303 to operate a turbine and generator 304. Again, these may be any combination of air and hydraulic turbines and generators. The pressure regulator valve 301 is a system backup to insure that in the event of a wind-powered compressor failure, or a leak in the feed from the compressors, that high-pressure air does not escape from the system.

The means of expanding a volume to store energy has the further advantage that, at least for small-scale storage, much lower pressures are required, thereby dramatically reducing the cost of the required containment structure, as well as the amount of compressional heating. For example, in the embodiment of the invention described above, if a low-cost material with a density approximately double that of water, such as sand, is used to provide the weight for the piston head that must be raised against the force of gravity by the expanding compressed air in the cylinder, then approximately one megawatt-hour of energy could be stored by raising by 15 meters a 30-meter diameter piston with a height of 15 meters; the pressure force required would be determined by the weight of the material in the piston head, and, for this example, would be approximately 60 psi. In contrast, the cavern in a conventional CAES system might be pressurized to over 1000 psi. In this embodiment of the invention, the piston and cylinder are supported by an above-ground containment structure, which consists of a wall built from an inexpensive material, supported by triangular beams embedded in the ground. This type of containment permits construction of very large containment structures at a very low cost per unit of energy stored.

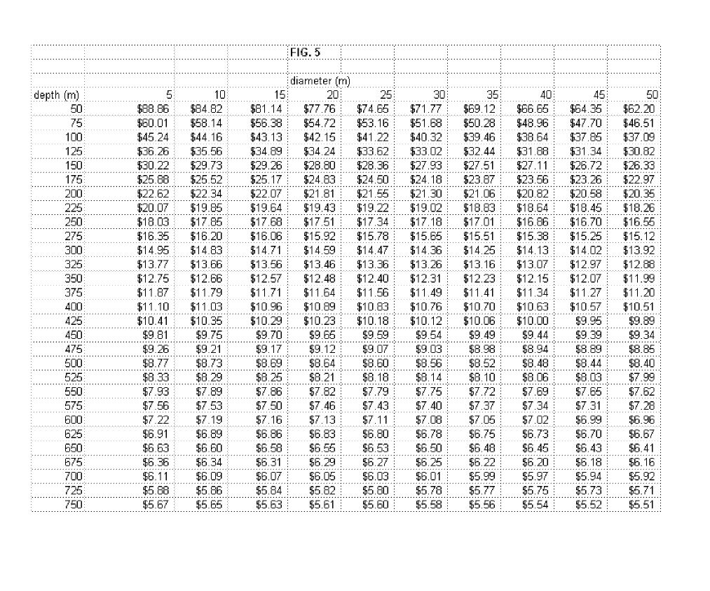

Another embodiment of the storage unit is described with reference to FIG. 4. In this embodiment, which is a preferred embodiment for offshore and shoreline locations where underwater storage is required or available, there is at least one storage unit 400, which includes a hollow shell 405 of interior volume, V, 404, and mass M, which is located in a body of water, generally at the bottom, at depth d. The weight of the shell 405, augmented by ballast 403, serves to anchor the shell on the bottom, preventing it from floating due to the buoyancy force exerted by the compressed air inside. Water is permitted to flow freely into and out of the shell 405 through at least one opening 406 at the bottom of the shell. The feed from the wind turbine and compressor 103 enters the shell through the valve 401 and feed 407. When compressed air enters the shell it does work against the pressure of the water (which is determined by the depth of the shell) to force water out of the shell. Compressed air is withdrawn from the shell via another valve 408 and feed 409, which delivers it to an air turbine 402. The air turbine runs a generator 411. A governor 412 controls the rate at which compressed air is withdrawn from the storage unit, to match the instantaneous demand for electric power. The power generation system may also include an underwater hydraulic turbine (not shown in FIG. 4) that is operated by water flowing into the shell as compressed air is withdrawn. The pressure regulator valve 401 is also a system backup to insure that in the event of a wind-powered compressor failure, or a leak in the feed from the compressors, that high-pressure air does not escape from the system. Other configurations of feeds and valves may be employed.

To anchor the storage unit against the buoyancy force due to the compressed air inside it, the storage unit mass must be greater than ρV(ρ_{w}−ρₐ)/(ρ−ρ_{w}) where ρ is the density of the material of which the storage unit is made, ρ_{w} is the density of the water at the depth, d, of the unit, and ρₐ is the density of the air inside the storage unit. Alternatively, the storage unit can be attached in any manner to the bottom of the body of water, in which case the mass of the unit can be arbitrarily low. The energy storage capacity, E, of the storage unit will be equal to the sum of the stored mechanical energy plus the increase in the gravitational potential energy of the displaced water plus the energy required to transport compressed air to the depth of the storage unit by doing work against the buoyancy force, E=PV+M_{w}hg+gdVρ_{w}=Vg ρ_{w}d(2+h/d). Again, the cost per unit of storage is very low. Since there are no moving parts and no consumables, the cost to operate the storage unit is minimal. The capital cost of the unit is the sum of the materials cost, the fabrication cost and the installation cost. Since storage capacity increases with depth, the materials and construction cost of a storage unit per unit of energy stored decreases with depth. Also, unless the storage unit is attached to the bottom, the materials cost per unit of energy stored is approximately independent of the capacity of the unit, since both the required mass to anchor the storage unit, which determines the materials cost, and the energy storage capacity of the unit are proportional to the volume of the unit. Therefore the optimum capacity of a storage unit will be determined by how fabrication and installation costs vary with capacity and depth. FIG. 5 gives the materials cost per kilowatt hour for a spherical storage unit as a function of diameter and depth (both in meters), assuming the material used for the storage unit and ballast has a density of 1.75 gm/cm³ and costs $10 per ton.

In shallow bodies of water lower storage costs may be achievable by attaching the storage unit to the bottom, thereby greatly reducing the materials cost required to anchor the unit against the buoyancy force. In deep water, where the cost of any work required to be performed on the bottom would be higher, anchoring by using a storage unit with the required mass may offer the lowest costs per unit of energy stored.

Where a liquid, typically water, provides the sealing mechanism for the compressed air, and also provides or augments the pressure on the stored volume of air, it can be used to turn a hydraulic motor or hydraulic turbine. In these embodiments of the invention, the liquid flows out of the storage chamber when compressed air is forced into the chamber, and it flows back into the chamber when air is released from it. The flow rate is proportional to the rate at which the volume of the chamber decreases, and it is inversely proportional to the cross sectional area of the opening through which the liquid enters the chamber. This flow rate is controlled through valves and/or nozzles and the flowing water is used to turn a hydraulic motor or hydraulic turbine. When the turbine is operated by water flowing out of the chamber, storage of energy in the chamber will be slowed by the reaction force generated. Therefore, the invention can also rely upon two or more storage volumes, so that the turbine is operated only by inflowing water.

These embodiments of the invention also enable realization of the increased efficiency and reduced costs obtainable with hydraulic turbines and generators, which can be over 90%. Furthermore, for underwater operation, as in connection with offshore windfarms, one or more submerged turbines adjacent to the storage volume will contribute to the required mass to anchor the air-filled volume, thereby eliminating the potentially high materials cost that could otherwise be incurred by virtue of the anchoring requirement.

When a hydraulic turbine is operated by inflowing water, it will not use 100% of the energy stored in the compressed air. This is particularly true for deep underwater operation, where the energy stored is augmented by the work done in transporting air to the underwater location against the buoyancy force. It is also true for terrestrial operation, where a contained volume of water is used to provide a means of generating a pressure force and to confine compressed air to the storage chamber; in such operation the energy stored is augmented by the work done in raising the level of the water in the containment structure against the force of gravity. Therefore, in most embodiments of the invention there will be at least one air motor, turbine or piston driven by compressed air to generate rotational motion, as described above. In a preferred embodiment of the invention, the hydraulic turbine and the air motor are combined into the same device, in which both the inflowing water and the expanding compressed air generate torques that turn the same shaft, which rotates the armature of a generator.

When energy is stored by means of a pumped, pressurized fluid, which is possible only for locations on land, the inefficiencies associated with the use of compressed air are eliminated.

When stored compressed air is used to operate an air motor or turbine, inefficiencies associated with the use of compressed air in conventional CAES systems are also eliminated. In conventional CAES, air is withdrawn from a fixed storage volume, resulting in a drop in pressure. Depressurization, in turn, cools the air, in accordance with Equation 1 above; it is the opposite of compressional heating. The cool air cannot run a turbine efficiently, with the result that a fuel such as natural gas is typically burned to heat the air. However, in all embodiments of the present invention which use compressed air as the storage medium, air is withdrawn from the storage unit by contracting the storage volume at constant pressure. When a gas is contracted adiabatically at constant pressure, its temperature increases as its volume decreases; the rate of change of temperature with volume is given by

$$\frac{d T}{d V} = ( 1 - γ ) {V}^{- γ} \qquad Equation 3$$

For air, since γ>1, this is always negative. As a result, the change in temperature resulting from a decrease in gas volume from a greater initial volume V₁ to a lesser final volume V₂ is T₁[(V₁/V₂)^{2/5}−1], where T₁ is the initial temperature. Since this quantity is positive, it represents a temperature increase. The injection of heated air into an air motor or turbine thus reduces or eliminates the need for burning a fuel and thereby achieves higher efficiency.

When a hydraulic turbine is located deep underwater, as for an offshore windfarm, it is constructed to enable maintenance to be performed. Specifically, components that require periodic replacement are modularized so that they can be easily removed and installed by remotely controlled robots, and lubricating fluids are removed and injected via feed tubes from the surface. When major maintenance is required, the entire integrated storage/generation unit can be brought to the surface by means of the buoyancy force generated by the stored compressed air. During normal operation, this is counterbalanced by the weight of the unit, permitting it to remain at the desired depth. When maintenance is required, additional air is pumped into the storage volume or into dedicated storage units, causing the buoyancy force to increase, thereby floating the unit to the surface. Alternately, an integrated structure similar to gravity-based platforms used for deep-water oil-drilling, such as the Troll A platform in the North Sea, can be employed to house the storage unit, turbines, generators and control systems, and to support the wind turbines, with the weight of the entire structure providing the required force to anchor the storage unit.

The present invention is not intended to be limited to a system or method that must satisfy one or more of any stated or implied objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims and their legal equivalents.

What is claimed is:

1. An integrated wind-power electrical generation and compressed gas energy storage system comprising:
(i) at least one wind-powered compressor operated by means of a rotating shaft that transmits rotational power from vanes that rotate when the wind blows;
(ii) a first feed system, coupled to said at least one wind-powered compressor, by which compressed gas generated by at least one wind-powered compressor is conducted to and injected into at least one storage unit at a desired pressure;
(iii) at least one storage unit, fluidly coupled to said first feed system, in which energy storage is accomplished by expanding the volume of compressed gas at constant or nearly constant pressure against a generated force located within the at least one storage unit;
(iv) a first control system coupled to said feed system, configured for regulating the pressure and flux of gas in the feed system so that the pressure of the gas entering the storage unit is equal to or greater than the pressure in the storage unit, while the flux of gas entering the storage unit is permitted to vary when wind speed changes;
(v) a second control system, coupled to said feed system and to said storage unit, and configured for terminating the flow of compressed gas in the feed system and sealing the storage unit when wind speed falls below a minimum operational level;
(vi) a containment mechanism that prevents the compressed gas from escaping when the storage volume within a storage unit is partially or totally expanded;
(vii) a second feed system that conducts compressed gas from a storage unit to at least one turbine or other device that generates rotational motion and injects it into such device, causing it to rotate;
(viii) at least one electrical generator having an armature and coupled to said second feed system, in which said armature is rotated by a turbine or other device into which compressed gas is fed to generate rotational motion; and
(ix) a third control system that regulates the pressure and flux of the gas into each device that generates rotational motion such as to prevent over-pressurization of the storage unit and to match the instantaneous energy input to each electrical generator to the instantaneous electrical load, maintaining required frequency stability.

2. The system of claim 1 wherein the generated force is selected from the group including the weight of a solid or liquid, a spring or other mechanical means, or an electromagnetic means;

3. The system of claim 1, wherein energy storage is accomplished by means of at least one storage unit consisting of an upper chamber, a lower chamber and a fluid, which (i) is displaced from the lower chamber into the upper chamber as compressed gas is fed into the lower chamber, in such manner that work is done expanding the volume of compressed gas in the lower chamber against the pressure created by the weight of the fluid, and additional work is done raising the fluid into the upper chamber against the force of gravity, and (ii) flows back from the upper chamber into the lower chamber as compressed gas is withdrawn to generate electricity.

4. The system of claim 3, wherein, as stored compressed gas is withdrawn from the lower chamber, the fluid flowing back into the lower chamber from the upper chamber turns a hydraulic turbine to generate electricity.

5. The system of claim 1, wherein energy storage is accomplished by means of at least one storage chamber in which (i) a movable weight is raised by the pressure of compressed gas as it is fed into the chamber, in such manner that work is done expanding the volume of compressed gas in the chamber, and additional work is done raising the weight against the force of gravity; (ii) the movable weight falls as compressed gas is withdrawn from the storage unit to generate electricity; (iii) the space between the movable weight and the wall of the chamber is sealed to prevent the escape of stored compressed gas; and (iv) the maximum and minimum elevation of the weight are controlled.

6. The system of claim 5, wherein the compressed gas is contained by a deformable material, the interior volume of which expands to fill a storage chamber as the weight is lifted, and contracts as the weight is lowered.

7. The system of claim 1, wherein energy storage is accomplished by means of at least one rigid storage chamber submerged in a body of water at a selected depth, into and out of which water is permitted to flow freely through at least one hole in the bottom as compressed gas is fed into or withdrawn from the chamber, such that as compressed gas is fed into the chamber work is done against the force created by the hydrostatic pressure of the water at the selected depth, additional work is done raising the displaced water against the force of gravity, and further work is done transporting the compressed gas to the selected depth against the buoyancy force, while the storage chamber is held at the selected depth by means of any combination of the weight of the storage chamber, the weight of system components, the weight of ballast added to it for that purpose, and attachment to the floor of the body of water.

8. The system of claim 7, wherein, as stored compressed gas is withdrawn from the storage chamber, the inflowing water turns a hydraulic turbine to generate electricity.

9. The system of claim 1, wherein electricity is generated by means of a generator driven by an air motor or air turbine, in which compressed gas fed from the storage unit is expanded against the vanes of the motor or turbine to create rotational motion.

10. The system of claim 1, wherein electricity is generated by means of a generator driven by a hydraulic motor or hydraulic turbine, in which a pressurized hydraulic fluid is used to apply a force to the vanes of the motor or turbine to create rotational motion, and the hydraulic fluid is pressurized by the use of compressed gas fed from the storage unit.

11. The system of claim 1, wherein electricity is generated by means of a reciprocating engine/generator combination, in which pistons are driven by compressed gas fed from the storage unit to cause a shaft to rotate.

12. The system of claim 1, wherein thermal insulation is used to prevent the escape of heat from the wind-powered compressor, the feeds, and the storage unit.

13. The system of claim 1, wherein a heat exchanger is used to transport heat from one part of the system to another.

14. A system for generating and storing compressed air comprising:
(i) at least one wind-powered air compressor operated by means of a rotating shaft that transmits rotational power from vanes that rotate when the wind blows;
(ii) a feed system by which compressed air generated by at least one wind-powered air compressor is conducted to and injected into at least one storage unit; and
(iii) at least one storage unit, coupled to said feed system, configured for storing and releasing compressed air for use.

15. An integrated wind-power electrical generation and pressurized fluid energy storage system comprising:
(i) at least one wind-powered pump operated by means of a rotating shaft that transmits rotational power from vanes that rotate when the wind blows;
(ii) a first feed system coupled to said at least one wind-powered compressor, by which fluid pressurized by at least one wind-powered pump is conducted to and injected into at least one storage unit at a desired pressure;
(iii) at least one storage unit, fluidly coupled to said first feed system, in which energy storage is accomplished by expanding the volume of pressurized fluid at constant or nearly constant pressure against a generated force located within the at least one storage unit;
(iv) a first control system coupled to said feed system, configured for regulating the pressure and flux of fluid in the feed system so that the pressure of the fluid entering the storage unit is equal to or greater than the pressure in the storage unit, while the flux of fluid entering the storage unit is permitted to vary when wind speed changes;
(v) a second control system coupled to said feed system and to said storage unit, and configured for terminating the flow of pressurized fluid in the feed system and sealing the storage unit when wind speed falls below a minimum operational level;
(vi) a containment mechanism that prevents the pressurized fluid from escaping when the storage volume within a storage unit is partially or totally expanded;
(vii) a second feed system that conducts pressurized fluid from a storage unit to at least one turbine or other device that generates rotational motion and injects it into such device, causing it to rotate;
(viii) at least one electrical generator having an armature and coupled to said second feed system, in which said armature is rotated by a turbine or other device into which pressurized fluid is fed to generate rotational motion; and
(ix) a third control system that regulates the pressure and flux of the fluid into each device that generates rotational motion such as to prevent over-pressurization of the storage unit and to match the instantaneous energy input to each electrical generator to the instantaneous electrical load, maintaining required frequency stability.

16. The system of claim 15 wherein the generated force is selected from the group including the weight of a solid or liquid, a spring or other mechanical means, or an electromagnetic means;

17. The system of claim 15 wherein energy storage is accomplished by means of at least one storage unit consisting of an upper chamber, a lower chamber and an unpressurized fluid, which (i) is displaced from the lower chamber into the upper chamber as a pressurized fluid is pumped into the lower chamber, in such manner that work is done expanding the volume of pressurized fluid in the lower chamber against the pressure created by the weight of the unpressurized fluid, and additional work is done raising the fluid into the upper chamber against the force of gravity, and (ii) flows back from the upper chamber into the lower chamber as pressurized fluid is withdrawn to generate electricity.

18. The system of claim 15, wherein energy storage is accomplished by means of at least one storage chamber in which (i) a movable weight is raised by the pressure of a pressurized fluid as it is pumped into the chamber, in such manner that work is done expanding the volume of pressurized fluid in the chamber, and additional work is done raising the weight against the force of gravity; (ii) the movable weight falls as pressurized fluid is withdrawn from the storage unit to generate electricity; (iii) the pressurized fluid is contained within the chamber by any means; and (iv) the maximum and minimum elevation of the weight are controlled.

19. The system of claim 18, wherein the pressurized fluid is contained by a deformable material, the interior volume of which expands to fill a storage chamber as the weight is lifted, and contracts as the weight is lowered.

20. The system of claim 15, wherein electricity is generated by means of a generator driven by a hydraulic motor or hydraulic turbine, in which the pressurized hydraulic fluid is used to apply a force to the vanes of the motor or turbine to create rotational motion.

21. The system of claim 15, wherein electricity is generated by means of a reciprocating engine/generator combination, in which pistons are driven by pressurized fluid fed from the storage unit to cause a shaft to rotate.

22. An energy storage system in which energy is stored by expanding a volume of a compressed gas against an applied force.

23. The system of claim 22 in which the applied force is generated by the weight of a solid or liquid, a spring or other mechanical means, or an electromagnetic means.

24. The system of claim 22 in which the applied force is generated by the pressure of water at a chosen depth in a natural or artificial body of water.

25. The system of claim 22 in which a pumped liquid is used instead of a compressed gas.

26. The system of claim 23 in which a pumped liquid is used instead of a compressed gas.
